(19) United States
(12) Patent Application Publication
(10) Pub. No.: US 2014/0058773 A1
(43) Pub. Date: Feb. 27, 2014

(54) DETERMINING CORPORATE ACTIONS USING TRANSACTIONAL DATA

(71) Applicants: Arya Kumar Vedabrata, Bhubaneswar (IN); Tvnr Kiran, Hyderabad (IN); Nandini Chilakuri, Hyderabad (IN)

(72) Inventors: Arya Kumar Vedabrata, Bhubaneswar (IN); Tvnr Kiran, Hyderabad (IN); Nandini Chilakuri, Hyderabad (IN)

(73) Assignee: Bank of America, Charlotte, NC (US)

(21) Appl. No.: 13/595,083

(22) Filed: Aug. 27, 2012

(51) Int. Cl. G06Q 10/00

(52) U.S. Cl. 705/7.11

(57) ABSTRACT

Aspects of the invention provide for the use of transactional data in determining a corporate action alert. Further aspects of the invention provide for determining a merger and acquisition utilizing employee base information generated from analyzing trends in historical transactional data. The method and processes may include the following: receiving transactional data corresponding to transactions associated with a set of customer accounts, wherein the transactional data includes business name patterns; generating employee base information using the transactional data, wherein the employee base information includes a total number of employees and a total amount of salary paid; identifying a trend for a merger and acquisition utilizing the employee base information; determining a list of the mergers and acquisitions from the trends for the mergers and acquisitions; and comparing the merger and acquisition list to a corporate database to identify data discrepancies.

### FIELD OF THE INVENTION

Aspects of the disclosure relate to using financial transactional data to assist in determining corporate actions. More specifically, aspects of the invention relate to determining corporate actions such as mergers and acquisitions.

### BACKGROUND

Currently, there is no merger and acquisition market event capturing system available using consumer transactional data. Consumer transactional data may be maintained in a database. The database may be a repository of transactions of all small business and retail consumers of a financial institution. The data may get captured from three different sources, such as debit cards, credit cards, and ACH. This consumer transactional data may include important details which can be utilized to provide a merger and acquisition market event capturing system.

Generally, back end systems at financial institutions need to be updated with corporate action information, such as mergers and acquisitions. Other corporate action information may include business name changes and demergers. This information helps to provide financial institutions with information about credit risk management, marketing opportunities, as well as regulatory reporting.

At financial institutions, corporate and commercial banking departments may be very dependent on the client relationship managers to report any specific corporate actions, such as mergers and acquisitions. The client relationship manager may struggle with reporting the corporate action details for small to midsize customers and companies. In other instances, the client relationship managers may report the mergers and acquisitions, but this reporting may be delayed and not timely. Generally, this lag of updating corporate action information may be delayed anywhere in between 2 months to a year. Additionally, approximately 50% of the companies may have either been delayed or not updated in the database systems. Timely information on corporate actions, such as mergers and acquisition, can enable a financial institution to take care of the data inconsistencies which ultimately will result in opportunities for the financial institution.

This lack of reporting or slow timeliness of reporting creates a gap in the information and data systems for corporate actions with what is the actual status of a financial institution's corporate customers. This lack of corporate action information, specifically regarding mergers and acquisitions, may decrease a financial institution's credit risk management. For example, if a good credit worthy company may acquire a bad credit-worthy company, the good credit-worthy company should be evaluated for credit again following the acquisition. However, if this information is delayed or not reported, the good credit-worthy company will not be evaluated. In another situation, the lack of corporate action information, specifically regarding mergers and acquisitions, may decrease a financial institution's marketing opportunities with could-be-customers following a merger/acquisition if the merger/acquisition is not reported or reported in an untimely manner. Lastly, the lack of corporate action information, specifically regarding mergers and acquisitions, may decrease a financial institution's ability to meet regulatory reporting compliance. For example, if a financial institution is not updating or untimely updating the corporate action information such as mergers and acquisitions, the financial institution may also be not reporting the correct information about their clients and/or corporate customers.

Therefore, a need exists for an improved method and system of determining corporate actions in a timely and accurate manner and then updating databases and data systems with this information.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

In one aspect of the invention, a computer-assisted method of determining corporate action alerts, the method may comprising the following steps: 1) receiving transactional data corresponding to transactions associated with a set of customer accounts, wherein the transactional data includes business name patterns; generating employee base information using the transactional data; identifying, using a processor, a trend for a corporate action utilizing the employee base information; and determining, using a processor, a list of the corporate actions from the corporate action trends. Additionally, the method may include the step of comparing the corporate action list to a corporate database to identify data discrepancies. Additionally, the method may include the step of updating the data discrepancies in the corporate database with the corporate action list.

In another aspect of the invention, the transactional data may include ACH transactions, credit card transactions, debit card transactions, or wire transactions. Furthermore, the trend of the corporate action may be defined by a trigger percentage difference of the employee base information from a previous month of data. The corporate action may be a merger and acquisition. The corporate action may also be a business name change or a demerger. Furthermore, the may be defined as a total number of employees and/or as a total amount of salary paid.

In another aspect of the invention, an apparatus may comprising: at least one memory; and at least one processor coupled to the at least one memory and configured to perform, based on instructions stored in the at least one memory: receiving transactional data corresponding to transactions associated with a set of customer accounts, wherein the transactional data includes business name patterns; generating employee base information using the transactional data; identifying a trend for a corporate action utilizing the employee base information; determining a list of the corporate actions from the corporate action trends; and comparing the corporate action list to a corporate database to identify data discrepancies and updating the data discrepancies in the corporate database with the corporate action list. The transactional data includes one or more of the following: ACH transactions, credit card transactions, debit card transactions, wire transactions. The corporate action may be a merger and acquisition. The corporate action may also be a business name change or a demerger.

A computer-readable storage medium storing computer-executable instructions that, when executed, cause a processor to perform a method comprising the steps of: 1) receiving transactional data corresponding to transactions associated with a set of customer accounts, wherein the transactional data includes business name patterns; 2) generating employee base information using the transactional data, wherein the employee base information includes a total number of employees and a total amount of salary paid; 3) identifying, using a processor, a trend for a merger and acquisition utilizing the employee base information; 4) determining, using a processor, a list of the mergers and acquisitions from the trends for the mergers and acquisitions; and 5) comparing the merger and acquisition list to a corporate database to identify data discrepancies and updating the data discrepancies in the corporate database with the mergers and acquisitions list.

### BRIEF DESCRIPTION OF THE DRAWINGS

The present disclosure is illustrated by way of example and not limited in the accompanying figures in which like reference numerals indicate similar elements.

FIG. 1 shows an illustrative operating environment in which various aspects of the invention may be implemented.

FIG. 2 is an illustrative block diagram of workstations and servers that may be used to implement the processes and functions of certain aspects of the present invention.

FIG. 3 illustrates a flow chart for determining corporate actions using transaction data.

FIGS. 4 through 6 show various illustrative tables for use with example embodiments in accordance with aspects of the invention.

### DETAILED DESCRIPTION

In accordance with various aspects of the invention, methods, computer-readable media, and apparatuses are disclosed for determining corporate actions, such as mergers and acquisitions. This method/process provides improved credit risk management, improved revenue and marketing opportunities, and improved regulatory and compliance risk as will be explained in detail below.

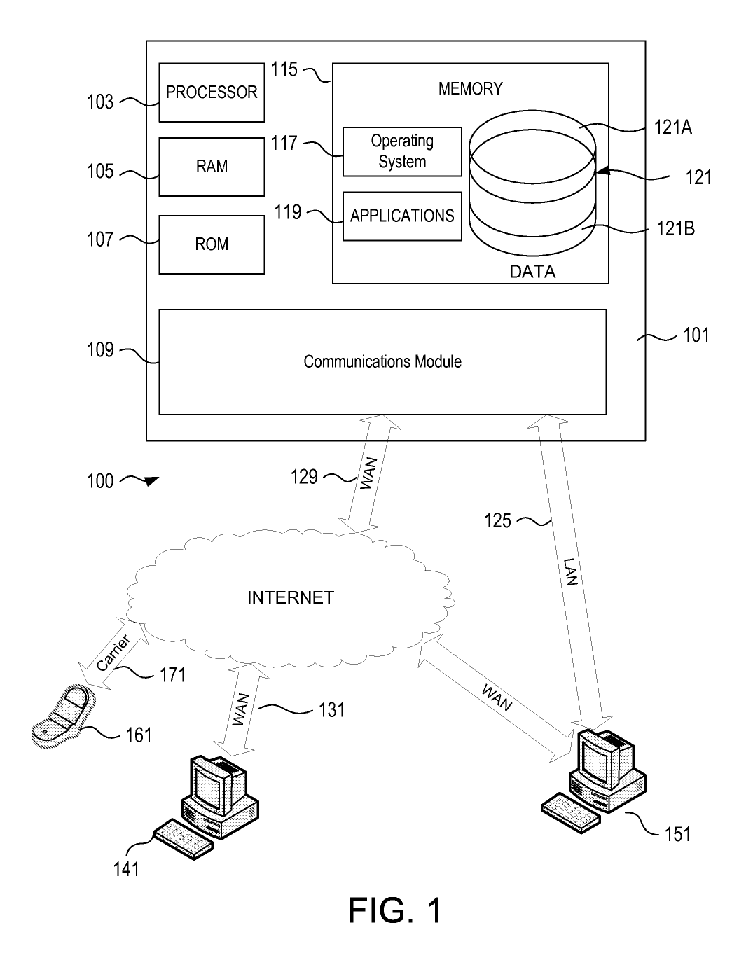

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality of the invention. The computing system environment 100 should not be interpreted as having any dependency or requirement relating to any one or combination of components shown in the illustrative computing system environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown).

Various databases 121 may be utilized with the processor 103 and the computing device 101. One example of a database 121 may be a consumer transaction database 121A. The consumer transaction database 121A may provide centralized storage of consumer transactions. The consumer transaction data may be historical or from separate channels, such as ACH transactions, credit card transactions, debit card transactions, wire transactions, and other similar consumer financial transactions. Additionally, the database may include a categorization and/or purpose of the transaction to arrive at a category of the transaction. Various categories may be utilized in accordance with this invention, such as: salary deposits from the employer, payments on mortgage loans, payments on card loan, payment on car loan, expenditures at grocery stores, purchases at retail stores, expenditures at restaurants, unemployment benefits, and gasoline expenses. Other various categories may be utilized without departing from this invention. The categorization of transactions in the consumer transaction database 121A may provide text mining and analytic capabilities. Additionally, the categorization of transactions in the consumer transaction database 121A may allow a financial institution to decipher and determine a purpose for the transaction.

Additionally, the consumer transaction database 121A may include a process of assigning the business name to a transaction. Every transaction may have a business name associated with it. For example, if there is a transaction where a customer is getting his salary deposited to his bank's account from Company A, then the business name may be listed as “Company A” and the category may be “Pay.” The business name assigning and standardization in the consumer transaction database 121A may provide text mining and data cleansing opportunities for the financial institution.

Additionally, the database 121 may include a separate database that may be a corporate database 121B. The corporate database 121B may include data and information about commercial and corporate clients for a financial institution. That data and information may include, but not be limited to: demographic information, risk rating, parent-subsidiary, product/account, and any other pertinent information regarding that corporate client. Generally, the corporate database 121B may receive updated information from frontline relationship managers.

Other databases 121 may be utilized without departing from this invention. The data for any database 121 may be received from different points in system 100, e.g., computers 141 and 151 or from communication devices, e.g., communication device 161.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. Branch computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 is connected to the LAN 125 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 101. Such a processor may execute computer-executable instructions stored on a computer-readable medium.

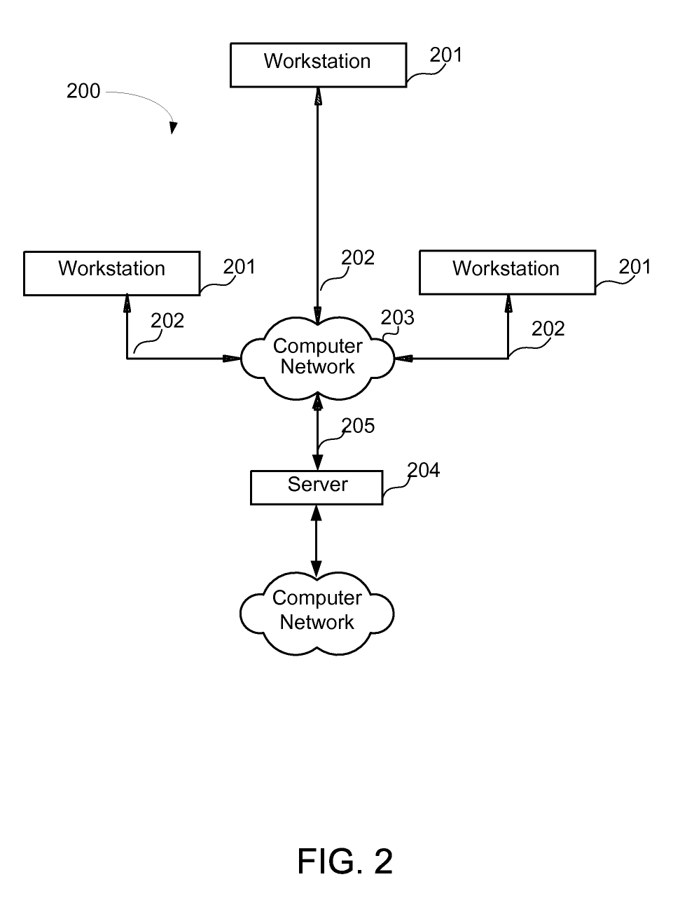

Referring to FIG. 2, an illustrative system 200 for implementing methods according to the present invention is shown. The system 200 may be a risk scenario system or a risk management system in accordance with aspects of this invention. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, and hard-wired links. Connectivity may also be supported to a CCTV or image/iris capturing device.

The steps that follow in the figures may be implemented by one or more of the components in FIGS. 1 and 2 and/or other components, including other computing devices.

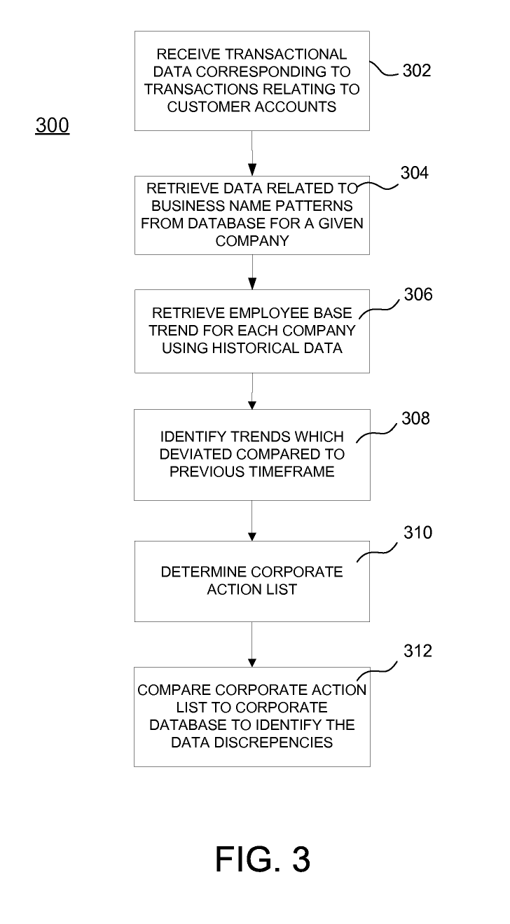

FIG. 3 illustrates a method of determining corporate actions using transactional data in accordance with an aspect of the invention. FIG. 3 shows a flow chart for determining and identifying corporate actions, such as mergers and acquisitions, demergers, or business name changes. This identification of mergers and acquisitions, demergers, and/or business name changes improves a financial institution's credit risk management, revenue opportunities, and regulatory and compliance risk. As illustrated in FIG. 3, the method may include one or more of the following steps: 1) receiving transactional data corresponding to transactions relating to customer accounts 302; 2) retrieving data related to business name patterns from a database for a given company 304; 3) retrieving employee base trend for each company using historical data 306; 4) identifying trends which deviated compared to previous timeframe 308; 5) determining corporate action list 310; and 6) comparing corporate action list to corporate database to identify the data discrepancies 312.

FIG. 3 illustrates a first step in the process, receiving transactional data corresponding to transactions relating to customer accounts 302. The transactional data may be stored in a database 121 and more specifically the consumer transaction database 121A. The consumer transaction data may be historical or from separate channels, such as ACH transactions, credit card transactions, debit card transactions, wire transactions, and other similar consumer financial transactions.

Additionally, this step 302 may include the categorization of the consumer financial transactions within the database 121A to arrive at a category of the transaction. Various categories may be utilized in accordance with this invention, such as: salary deposits from the employer, pension payments from the employer, payments on mortgage loans, payments on card loan, payment on car loan, expenditures at grocery stores, purchases at retail stores, expenditures at restaurants, unemployment benefits, and gasoline expenses. Other various categories may be utilized without departing from this invention. The categorization of transactions in the consumer transaction database 121A may provide text mining and analytic capabilities. Additionally, the categorization of transactions in the consumer transaction database 121A may allow a financial institution to decipher and determine a purpose for the transaction.

Additionally, this step 302 may include assigning a business name to each of the transactions in the consumer transaction database 121A. Every transaction may have a business name associated with it. For example, if there is a transaction where a customer is getting his salary deposited to his bank's account from Company A, then the business name may be listed as “Company A” and the category may be “PAY.” The business name assigning and standardization in the consumer transaction database 121A may provide text mining and data cleansing opportunities for the financial institution.

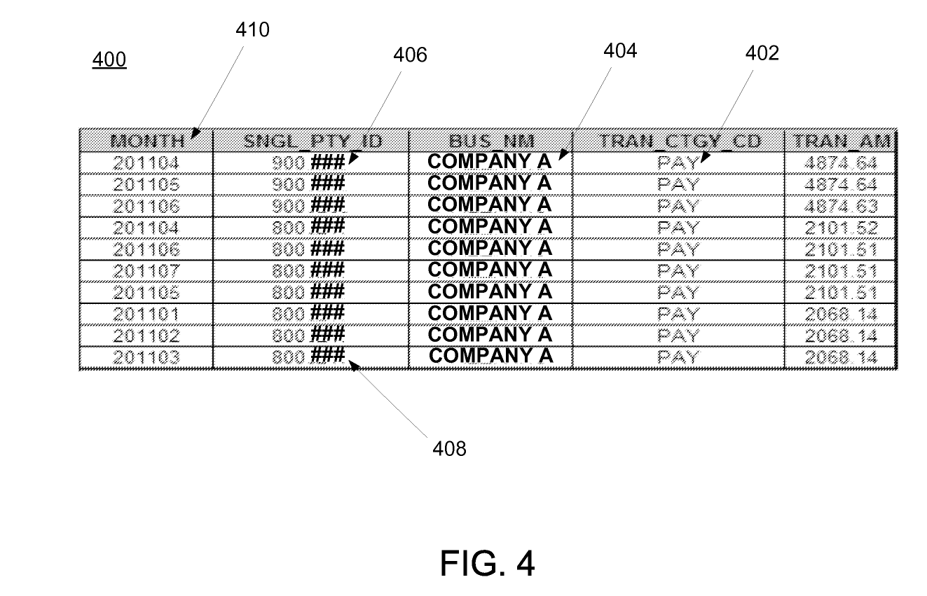

FIG. 3 illustrates another step in the process, retrieving data related to business name patterns from a database for a given company 304. For example, during this step, the method or process may include retrieving the data for a given company in a given category. Specifically, with regards to this invention, the method may include retrieving all the transactions labeled as ACH within the transaction categories of salary payments from the company and pension payments from the company. FIG. 4 illustrates an example table 400 that represents a transaction category of “PAY” 402 for a given company, “Company A” 404 for two different employees, “900###” 406 and “800###” 408 over a time period 410. This table 400 of information, along with the data retrieved from the entire database, may be utilized in the follow-on steps.

FIG. 3 illustrates another step in the process, retrieving employee base trend for each company using the historical consumer transaction data 306. During this step, the method or process includes the compilation of the consumer transaction data specifically retrieved in the above step 304 for each of the companies. The compilation of the consumer transactional data for a given company or business name will show a financial institution's employee base for that given company. Generally, this employee base will represent the number of employees who are clients of the financial institution who are also employed by the given company. This employee base can be measured by both the total number of employees who are clients of the financial institution and the total amount of payments to the clients of the financial institution. Additionally, this transaction data may be retrieved over a given timeframe, such as over an 18 month period. This transaction data may also be retrieved over a given time interval, such as monthly.

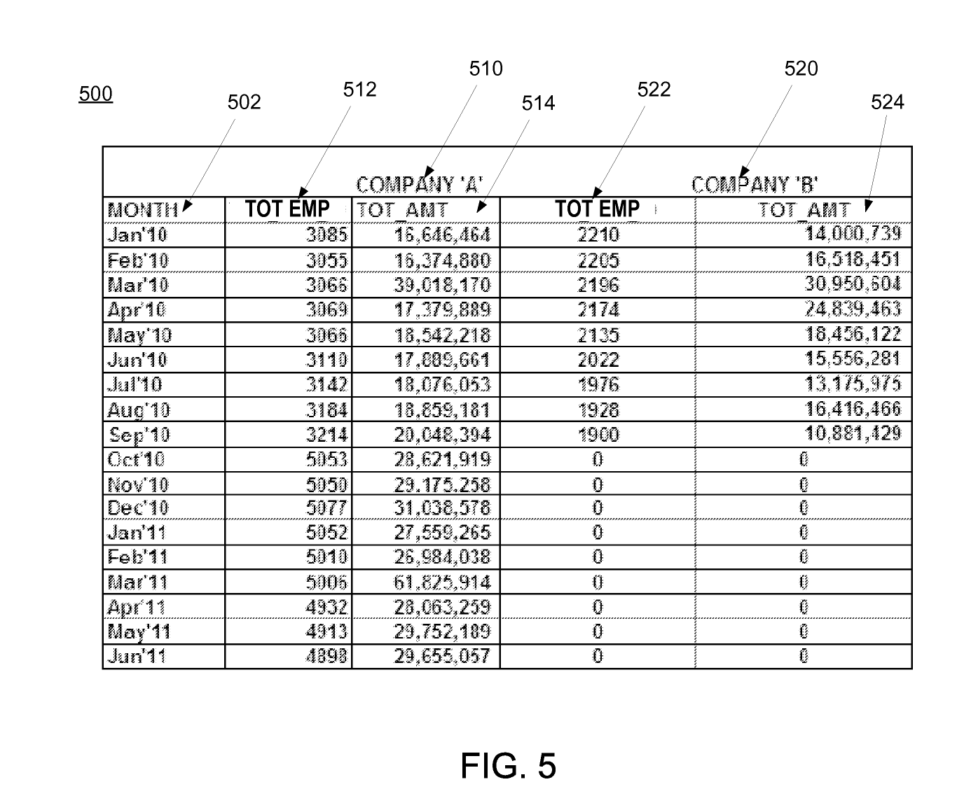

FIG. 5 illustrates an example table 500 for payroll data of two different companies, Company A 510 and Company B 520 and their respective employee base over time. Table 500 illustrates the employee base over an 18 month timeframe in monthly intervals 502. For Company A 510, table 500 illustrates a monthly listing of “TOT EMP” 512 or the total employee base and the TOT_AMT 514 or the total amount received as pay from Company A by the employee base. For Company B 520, table 500 illustrates a monthly listing of “TOT EMP” 522 or the total employee base and the TOT_AMT 524 or the total amount received as pay from Company B by the employee base. Table 500 illustrates the employee base trend for each company using historical data.

FIG. 3 illustrates another step in the process, identifying trends which deviated compared to the previous timeframe 308. During this step, the trend analysis may be a trigger to study a shift in either the number of the employee base and/or the total amount paid to the employee base over a given time. During this step, a sudden drop or spike in either of these values may be a trigger. Additionally, to identify the trend, a company making similar payments to at least 50% of the employee base from the previous month may be a trigger. Other percentages may be utilized without departing from this invention. For example, the trigger percentage may include, but not be limited to, 25%, 40%, 60%, or even 75% of the employee base from the previous month. These trigger percentage values may be tested and evaluated with these methods and processes as further data is maintained and analyzed.

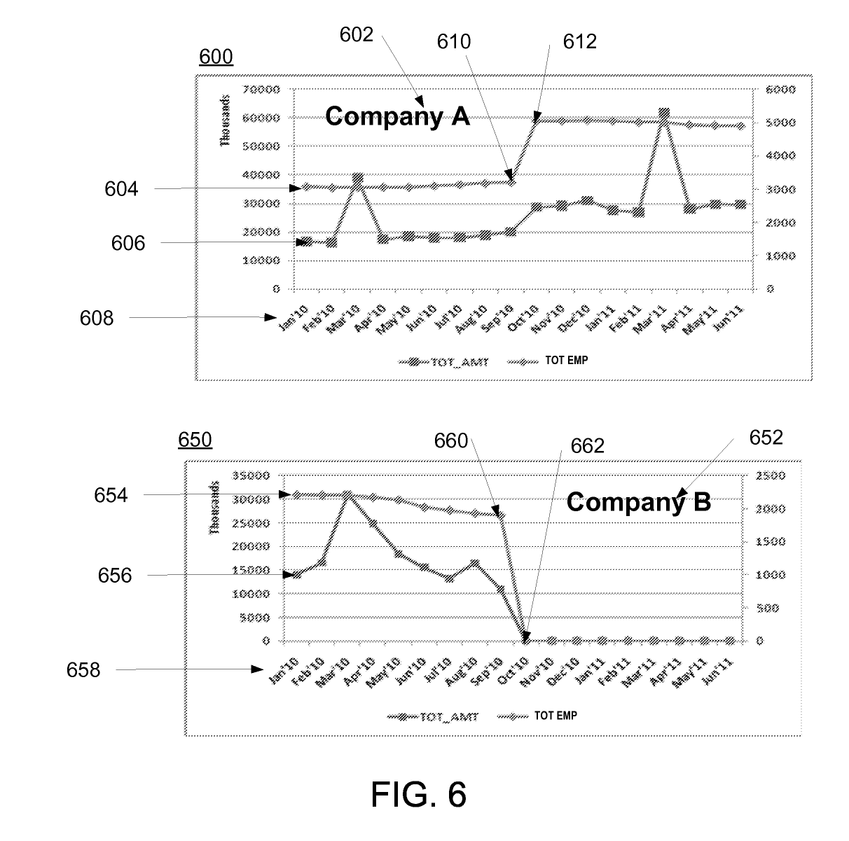

FIG. 6 illustrates two sample tables 600 and 650 which visually illustrate the step of identifying trends which deviated compared to the previous timeframe in step 308. Table 600 represents a table for Company A 602 that includes a line graph of the employee base represented by “TOT EMP” 604 and a line graph of total amount paid to the baseline employees represented by “TOT_AMT” 606 with monthly time 608 on the horizontal axis. Table 650 represents a table for Company B 652 that includes a line graph of the employee base represented by “TOT EMP” 654 and a line graph of total amount paid to the baseline employees represented by “TOT_AMT” 656 with monthly time 658 on the horizontal axis.

In this given example, for Company A 602, the employee base 604 has been increased from 3,214 in September 2010 610 to 5,053 in October 2010 612. This represents a percentage increase of almost 57%. For Company B 652, the employee base 654 has been decreased from 1,900 in September 2010 660 to 0 in October 2010 662. This represents a percentage decrease of 100%. Additionally, since October 2010 onward, there is no data available up to June 2011. In this example, the root cause for these trends may be identified as Company A 602 acquiring Company B 652 on or around September or October 2010.

In accordance with another aspect of this invention, these trigger percentages may trigger an additional study for any merger and acquisition (or other corporate action) in the market related to the company under scrutiny. A market data study may be performed on a given company or set of companies which meet or exceed the threshold of the trigger percentage. This market data study may include internet and information research reports on the identified companies to determine if a merger and acquisition did occur.

FIG. 3 illustrates another step in the process, determining corporate action list 310. During this step, the methods and/or process may determine the list of corporate actions based on the previous steps. For example, based on the trend analysis from step 308, a list of corporate actions may be determined. Additionally, following the trend analysis and a possible market data study, a list of corporate actions may be determined. As has been stated previously, the corporate actions may include mergers and acquisitions, demergers, and business name changes. In another embodiment of the invention, the corporate action list may be output in a report format.

In another embodiment of the invention, this step may include determining a mergers and acquisition list 310. During this step, the methods and/or process may determine the list of mergers and acquisition based on the previous steps. For example, based on the trend analysis from step 308, a list of mergers and acquisition may be determined. Additionally, following the trend analysis and a possible market data study, a list of mergers and acquisition may be determined. In another embodiment of the invention, the mergers and acquisition list may be output in a report format.

FIG. 3 illustrates another step in the process, comparing the list of corporate actions identified in step 310 to a corporate database 121B (or other databases as well) to identify the data discrepancies 312. During this step, the corporate action list determined from the previous step, step 310 may be compared to a corporate database 121B for each of the corporate action list companies. This comparison may identify data discrepancies. Additionally, the corporate action list determined from step 310 may also be further refined to have companies which have not been updated in the corporate database 121B. In another embodiment of the invention, following the comparison of the list of corporate actions identified in step 310 and confirmation of the corporate actions, the owner of the corporate database 121B may update the corporate database 121B (or other databases 121 as needed or required) to ensure that the most up to date and timely information is input into the system.

In another embodiment of the invention, this step may include comparing the list of mergers and acquisitions identified in step 310 to a corporate database 121B (or other databases 121 as well) to identify the data discrepancies 312. During this step, the mergers and acquisitions list determined from step 310 may be compared to a corporate database 121B for each of the mergers and acquisition companies. This comparison may identify data discrepancies. Additionally, the mergers and acquisitions list determined from step 310 may also be further refined to have companies which have not been updated in the corporate database 121B. In another embodiment of the invention, following the comparison of the list of mergers and acquisitions identified in step 310 and confirmation of the mergers and acquisitions, the owner of the corporate database 121B may update the corporate database 121B (or other databases 121 as needed or required) to ensure that the most up to date and timely information is input into the system.

In another embodiment of this invention, other corporate actions may be determined using these methods and processes. For example, wherein payroll data may be utilized for merger and acquisition alerts, that same payroll data or business names may be utilized for alerts for business name changes or demergers. For example, say Company A changes their name to Company A1. The payroll data will now show a different company for the employee base, changing from a business name of Company A to Company A1.

Determining corporate action alerts, and specifically identifying mergers and acquisitions, offers numerous business values and benefits. First, determining mergers and acquisitions provides better credit risk management for a financial institution. Any merger or acquisition should result in a revision or at least a review of a credit risk rating of the acquiring companies. In the scenario of inconsistent data, the risk system will not be able to reflect the reality.

Another business value and benefit is the improved revenue opportunities. By identifying mergers and acquisitions sooner, the financial institution will have better and bigger insights. Post acquisition, the financial institution may extend relationships to the acquired companies. Additionally, post-merger and acquisition clients might have special requirements and needs of financial products. Furthermore, it will give financial institutions the ability to retain and deepen existing customer/client relationships using the latest and most up-to-date information.

Another business value and benefit of identifying mergers and acquisitions more timely and accurately is that it improves the regulatory and compliance risk. Regulatory and compliance risk may be one of the biggest risks in a financial institution, so it is important to help to eliminate or at least manage this risk efficiently. Data inconsistencies may lead to incorrect regulatory reporting. Additionally, Basel II IRB approach may result in reporting incorrect risk rating and corresponding capital requirements.

Although not required, one of ordinary skill in the art will appreciate that various aspects described herein may be embodied as a method, a data processing system, or as a computer-readable medium storing computer-executable instructions. Accordingly, those aspects may take the form of an entirely hardware embodiment, an entirely software embodiment or an embodiment combining software and hardware aspects. In addition, various signals representing data or events as described herein may be transferred between a source and a destination in the form of electromagnetic waves traveling through signal-conducting media such as metal wires, optical fibers, and/or wireless transmission media (e.g., air and/or space).

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

We claim:

1. A computer-assisted method of determining corporate action alerts, the method comprising:
receiving transactional data corresponding to transactions associated with a set of customer accounts, wherein the transactional data includes business name patterns;
generating employee base information using the transactional data;
identifying, using a processor, a trend for a corporate action utilizing the employee base information; and
determining, using a processor, a list of the corporate actions from the corporate action trends.

2. The method of claim 1, further including comparing the corporate action list to a corporate database to identify data discrepancies.

3. The method of claim 2, further including updating the data discrepancies in the corporate database with the corporate action list.

4. The method of claim 1, wherein the transactional data includes ACH transactions.

5. The method of claim 1, wherein the transactional data includes credit card transactions.

6. The method of claim 1, wherein the transactional data includes debit card transactions.

7. The method of claim 1, wherein the transactional data includes wire transactions.

8. The method of claim 1, wherein the trend of the corporate action is defined by a trigger percentage difference of the employee base information from a previous month of data.

9. The method of claim 8, wherein the trigger percentage difference is 50%.

10. The method of claim 1, wherein the corporate action is a merger and acquisition.

11. The method of claim 1, wherein the corporate action is a business name change.

12. The method of claim 1, wherein the employee base is defined as a total number of employees.

13. The method of claim 1, wherein the employee base is defined as a total amount of salary paid.

14. An apparatus comprising:
at least one memory; and
at least one processor coupled to the at least one memory and configured to perform, based on instructions stored in the at least one memory:
receiving transactional data corresponding to transactions associated with a set of customer accounts, wherein the transactional data includes business name patterns;
generating employee base information using the transactional data;
identifying a trend for a corporate action utilizing the employee base information;
determining a list of the corporate actions from the corporate action trends; and
comparing the corporate action list to a corporate database to identify data discrepancies and updating the data discrepancies in the corporate database with the corporate action list.

15. The method of claim 14, wherein the transactional data includes one or more of the following: ACH transactions, credit card transactions, debit card transactions, wire transactions.

16. The method of claim 14, wherein the trend of the corporate action is defined by a trigger percentage difference of the employee base information from a previous month of data.

17. The method of claim 14, wherein the corporate action is a merger and acquisition.

18. The method of claim 14, wherein the corporate action is a business name change.

19. A computer-readable storage medium storing computer-executable instructions that, when executed, cause a processor to perform a method comprising:
receiving transactional data corresponding to transactions associated with a set of customer accounts, wherein the transactional data includes business name patterns;
generating employee base information using the transactional data, wherein the employee base information includes a total number of employees and a total amount of salary paid;
identifying, using a processor, a trend for a merger and acquisition utilizing the employee base information;
determining, using a processor, a list of the mergers and acquisitions from the trends for the mergers and acquisitions; and
comparing the merger and acquisition list to a corporate database to identify data discrepancies and updating the data discrepancies in the corporate database with the mergers and acquisitions list.

20. The method of claim 19, wherein the trend of the merger and acquisition is defined by a trigger percentage difference of the total number of employees and the total amount of salary paid from a previous month of data.
